(19) United States
(12) Patent Application Publication
(10) Pub. No.: US 2008/0204598 A1
(43) Pub. Date: Aug. 28, 2008

(54) Real-time film effects processing for digital video

(76) Inventors: Lance Maurer, Albuquerque, NM (US); Chris Gorman, Albuquerque, NM (US); Dillon Sharlet, Albuquerque, NM (US)

Correspondence Address: PEACOCK MYERS, P.C., 201 THIRD STREET, N.W., SUITE 1340, ALBUQUERQUE, NM, 87102, US

(21) Appl. No.: 12/001,265

(22) Filed: Dec. 11, 2007

Related U.S. Application Data
(60) Provisional application No. 60/869,516, filed on Dec. 11, 2006.
(60) Provisional application No. 60/912,093, filed on Apr. 16, 2007.

(51) Int. Cl. H04N 9/74; G06K 9/40

(52) U.S. Cl. 348/584; 382/274; 348/E09.055

(57) ABSTRACT

A method, apparatus, and computer software for applying in real time imperfections to streaming video which causes the resulting digital video to resemble cinema film.

### CROSS-REFERENCE TO RELATED APPLICATIONS

This application claims priority to and the benefit of the filing of U.S. Provisional Patent Application Ser. No. 60/869,516, entitled “Cinnafilm: A Real-Time Film Effects Processing Solution for Digital Video”, filed on Dec. 11, 2006, and of U.S. Provisional Patent Application Ser. No. 60/912,093, entitled “Advanced Deinterlacing and Framerate Re-Sampling Using True Motion Estimation Vector Fields”, filed on Apr. 16, 2007, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

© 2007 Cinnafilm, Inc. A portion of the disclosure of this patent document and of the related applications listed above contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The present invention relates to methods, apparatuses, and software for simulating film effects in digital images.

2. Description of Related Art

Note that the following discussion refers to a publication, and that due to recent publication date it is not to be considered as prior art vis-a-vis the present invention. Discussion of such publication herein is given for more complete background and is not to be construed as an admission that such publication is prior art for patentability determination purposes.

The need and desire to make video look more like film is a considerable challenge due to high transfer costs and limitations of available technologies that are not only time consuming, but provide poor results.

U.S. patent application Ser. No. 11/088,605, to Long et al. describes a system which modifies images contained on scan-only film to resemble that of an image captured on motion-picture film. This system, however, is limited to use in conjunction with special scan-only film and is not suitable for use in the now more-common digital images. Further, because the process of Long et al., is limited to scan-only film, the process of Long et al., cannot be used for streaming real-time or near real-time images. There is thus a present need for a method, apparatus, and system which can provide real-time or near real-time streaming digital video processing which alters the digital image to resemble images captured via motion picture film.

The present invention has approached the problem in unique ways, resulting in the creation of a method, apparatus, and software that not only changes the appearance of digital video footage to look like celluloid film, but performs this operation in real-time or near real-time. The invention (occasionally referred to as Cinnafilm™) streamlines current production processes for professional producers, editors, and filmmakers who use digital video to create their media projects. The invention permits independent filmmakers to add an affordable high quality film effect to their digital projects, provides a stand-alone film effects hardware platform capable of handling broadcast-level video signal, a technology currently unavailable in the digital media industry. The invention provides an instant film-look to digital video, eliminating the need for long rendering times associated with current technologies.

### BRIEF SUMMARY OF THE INVENTION

Embodiments of the present invention relate to a digital video processing method, apparatus, and software stored on a computer-readable medium having and/or implementing the steps of receiving a digital video stream comprising a plurality of frames, adding a plurality of film effects to the video stream, outputting the video stream with the added film effects, and wherein for each frame the outputting occurs within less than approximately one second. The adding can include adding at least two effects including but not limited to letterboxing, simulating film grain, adding imperfections simulating dust, fiber, hair, scratches, making simultaneous adjustments to hue, saturation, brightness, and contrast and simulating film saturation curves. The adding can also optionally include simulating film saturation curves via a non-linear color curve; simulating film grain by generating a plurality of film grain textures via a procedural noise function and by employing random transformations on the generated textures; adding imperfections generated from a texture atlas and softened to create ringing around edges; and/or adding imperfections simulating scratches via use of a start time, life time, and an equation controlling a path the scratch takes over subsequent frames. In one embodiment, the invention can employ a stream programming model and parallel processors to allow the adding for each frame to occur in a single pass through the parallel processors. Embodiments of the present invention can optionally include converting the digital video stream from 60 interlaced format to a deinterlaced format by loading odd and even fields from successive frames, blending using a linear interpolation factor, and, if necessary, offset sampling by a predetermined time to avoid stutter artifacts.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates a preferred interface menu according to an embodiment of the invention;

FIG. 2 illustrates a preferred graphical user interface according to an embodiment of the invention;

FIG. 3 is a block diagram of a preferred apparatus according to an embodiment of the invention;

FIG. 4 is a block diagram of the preferred video processing module of an embodiment of the invention;

FIG. 5 is a block diagram of the preferred letterbox mask, deinterlacing and cadence resampling module of an embodiment of the invention; and

FIG. 6 is an illustrative texture atlas according to an embodiment of the invention.

### DETAILED DESCRIPTION OF THE INVENTION

Embodiments of the present invention relates to a methods, apparatuses, and software to enhance moving, digital video images at the coded level to appear like celluloid film in real time (processing speed equal to or greater than ˜30 frames per second). Accordingly, with the invention processed digital video can be viewed “live” as the source digital video is fed in. So, for example, the invention is useful with video “streamed” from the Internet. The “film effects”, added by an embodiment of the invention, include one and more preferably at least two of: letterboxing, adding film grain, adding imperfections simulating dust, fiber, hair, chemical burns, scratches, and the like, making simultaneous adjustments to hue, saturation, brightness, and contrast, and simulating film saturation curves.

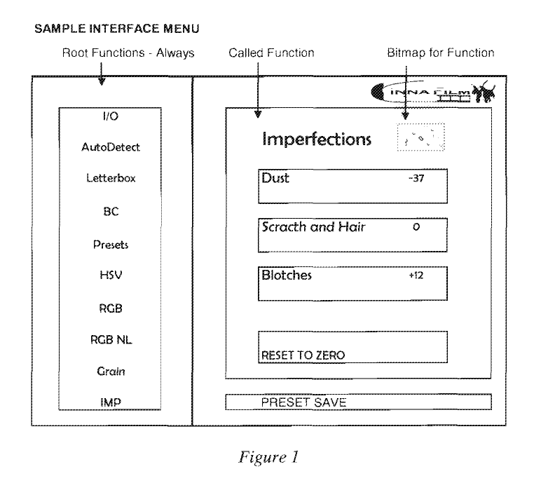

Although the invention can be implemented on a variety of computer hardware/software platforms, including software stored in a computer-readable medium, one embodiment of hardware according to the invention is a stand-alone device, which is next described. Internal Video Processing Hardware preferably comprises a general purpose CPU (Pentium4®, Core2 Duo®, Core2 Quad® class), graphics card (DX9 PS3.0 or better capable), system board (with dual 1394/Firewire ports, USB ports, serial ports, SATA ports), system memory, power supply, and hard drive. A Front Panel User Interface preferably comprises a touchpad usable menu for access to image-modification features of the invention, along with three dials to assist in the fine tuning of the input levels. The touchscreen is most preferably an EZLCD 5″ diagonal touchpad or equivalent, but of course virtually any touchscreen can be provided and will provide desirable results. With a touchscreen, the user can access at least some features and more preferably the entire set of features at any time, and can adjust subsets of those features in one or more of the following ways: (1) ON/OFF—adjusted with an on/off function on the touchpad; (2) Floating Point Adjustment (−100 to 100, 0 being no effect for example)—adjusted using the three dials; and/or (3) Direct Input—adjusted with a selection function on the touchpad. FIG. 1 illustrates a display provided by the preferred user interface.

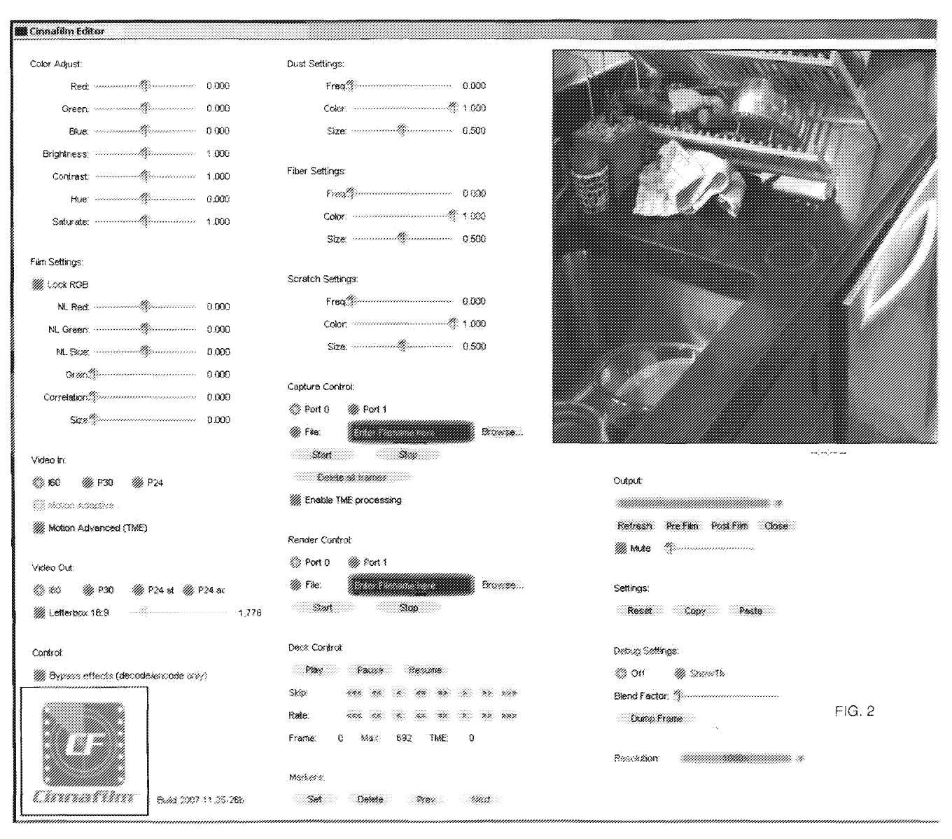

The invention can also or alternatively be implemented with a panel display and user keyboard and/or mouse. The user interface illustrated in FIG. 2 allows quicker access to the multitude of features, including the ability to display to multiple monitors and the ability to manipulate high-definition movie files.

The apparatus of the invention is preferably built into a sturdy, thermally proficient mechanical chassis, and conforms to common industry rack-mount standards. The apparatus preferably has two sturdy handles for ease of installation. I/O ports are preferably located in the front of the device on opposite ends. Power on/off is preferably located in the front of the device, in addition to all user interfaces and removable storage devices (e.g., DVD drives, CD-ROM drives, USB inputs, Firewire inputs, and the like). The power cord preferably extrudes from the unit in the rear. An Ethernet port is preferably located anywhere on the box for convenience, but hidden using a removable panel. The box is preferably anodized black wherever possible, and constructed in such a manner as to cool itself via convection only. The apparatus of the invention is preferably locked down and secured to prevent tampering.

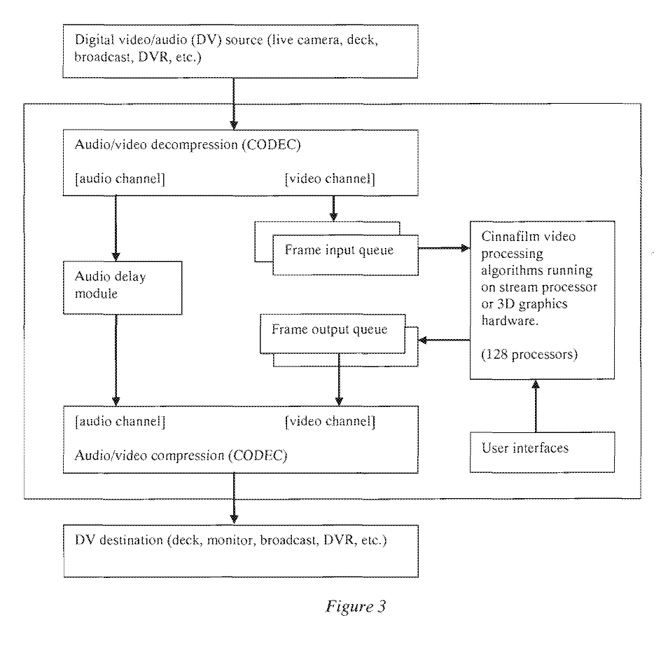

As illustrated in FIG. 3, an apparatus according to a non-limiting embodiment of the invention takes in a digital video/audio stream on a 1394 port and uses a Digital Video (DV) compression-decompression software module (CODEC) to decompress video frames and the audio buffers to separate paths (channels). The video is preferably decompressed to a two dimensional (2D) array of red, green, and blue color components (RGB image, 8-bits per component). Due to texture resource alignment requirements for some graphics cards, the RGB image is optionally converted to a red, green, blue, and alpha component (RGBA, 8-bits per component) buffer. The RGBA buffer is most preferably copied to the end of the input queue on the graphics card. The buffer is copied using direct memory access (DMA) hardware so that minimal CPU resources are used. On the graphics card, a video frame is preferably pulled from the front of the input queue and the video processing algorithms running on one or more processors, which can include hundreds of processors (128 in one implementation) to modify the RGBA data to achieve the film look. The processed frame is put on the end of the output queue. The processed video from the front of the output queue is then DMA'd back to system memory where it is compressed, along with the audio, using the software CODEC module. Finally, the compressed audio and video are then streamed back out to a second 1394 port to any compatible DV device.

Although other computer platforms can be used, one embodiment of the present invention preferably utilizes commodity x86 platform hardware, high end graphics hardware, and highly pipelined, buffered, and optimized software to achieve the process in realtime (or near realtime with advanced processing). This configuration is highly reconfigurable, can rapidly adopt new video standards, and leverages the rapid advances occurring in the graphics hardware industry.

Examples of supported video sources include, but are not limited to, the IEC 61834-2 standard (DV), the SMPTE 314M standard (DVCAM and DVCPRO-25, DVCPRO-50), and the SMPTE 370M (DVCPRO HD). In an embodiment of the present invention, the video processing methods can work with any uncompressed video frame (RGB 2D array) that is interlaced or non-interlaced and at any frame rate, although special features can require 60 fields per second interlaced (60i), 30 frames per second progressive (30p), or 24 frames per second progressive encoded in the 2:3 telecine (24p standard) or 2:3:3:2 telecine (24p advanced) formats. In addition to DV, there are numerous CODECs that exist to convert compressed video to uncompressed RGB 2D array frames. This embodiment of the present invention will work with any of these CODECs. Embodiments of the present invention can also provide desirable results when used in conjunction with high definition video.

The Frame Input Queue is implemented as a set of buffers, a front buffer pointer, and an end buffer pointer. When the front and end buffer pointers are incremented past the last buffer they preferably cycle back to the first buffer (i.e., they are circular or ring buffers). The Frame Output Queue is implemented in the same way. The Frame Input/Output Queues store uncompressed frames as buffers of uncompressed RGBA 2D arrays.

In a preferred embodiment of the present invention, a plurality of interface modules is preferably provided, which can be used together or separately. One user interface is preferably implemented primarily via software in conjunction with conventional hardware, and is preferably rendered on the primary display context of a graphics card attached to the system board, and uses keyboard/mouse input. The other user interface, which is preferably primarily a Hardware Interface, is preferably running on a microcontroller board that is attached to the USB or serial interfaces on the system board, is rendered onto an LCD display attached to microcontroller board, and uses a touch screen interface and hardware dials as input. Both interfaces display current state and allow the user to adjust settings. The settings are stored in the CFilmSettings object.

The CFilmSettings object is shared between the user interfaces and the video processing pipeline and is the main mechanism to effect changes in the video processing pipeline. Since this object is accessed by multiple independent processing threads, access can be protected using a mutual exclusion (mutex) object. When one thread needs to read or modify its properties, it must first obtain a pointer to it from the CSharedGraphicsDevice object. The CSharedGraphicsDevice preferably only allows one thread at a time to have access to the CFilmSettings object.

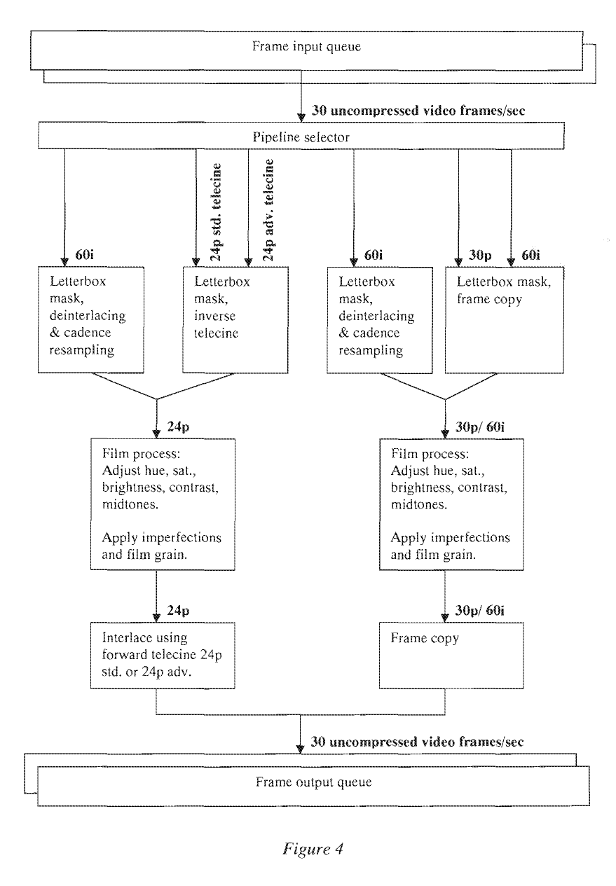

FIG. 4 shows details of the box labeled “Cinnafilm video processing algorithms” from FIG. 3. Uncompressed video frames enter the pipeline from the Frame Input Queue at the rate of 29.97 frames per second (NTSC implementation). On PAL implementations of the present invention, a rate of 25 frames per second is preferably provided. The video frame may contain temporal interlaced fields (60i), progressive frames (30p), or telecine interlaced fields (24p standard and 24p advanced). On PAL implementations, the video frame may contain temporal interlaced fields (50i) or progressive frames (25p).

In yet another embodiment of the present invention, the pipeline is a flexible pipeline that efficiently feeds video frames at a temporal frequency of 30 frames per second, handles one or more cadences (including but not limited to 24p or 30p), converts back to a predetermined number of frames per second, which can be 30 frames per second and preferably exhibits a high amount of reuse of software modules.

In a non-limiting embodiment, original video and film frames that have a temporal frequency of 24 frames per second are converted to 60 interlaced fields per second using the “forward telecine method”. The telecine method repeats odd and even fields from the source frame in a 2:3 pattern for standard telecine or a 2:3:3:2 pattern for advanced telecine. For example, let F(an) be a function that returns the odd or even field of a frame n, where q=o indicates odd fields, q=e indicates even fields. The standard 2:3 telecine pattern would be:
F(0,o), F(0,e), F(1,o), F(1,e), F(1,o), F(2,e), F(2,o), F(3,e), F(3,o), F(3,e), . . .
   For better visualization of the pattern, let 0o stand for F(0,o), 0e stand for F(0,e), 1o stand for F(1,o), etc. Using this one can rewrite the 2:3 telecine pattern as:
{0o, 0e, 1o, 1e, 1o, 2e, 2o, 3e, 3o, 3e, . . . }
   One can group these to emphasize the 2:3 pattern:
{0o, 0e}, {1o, 1e, 1o}, {2e, 2o}, {3e, 3o, 3e}, . . .
   Now grouped to emphasis the resulting interlaced frames:
{0o, 0e}, {1o, 1e}, {1o, 2e}, {2o, 3e}, {3o, 3e}, . . .
   Notice that fields from frame 0 were used 2 times, frame 1 used 3 times, frame 2 used 2 times, and frame 3 used 3 times. One can reconstruct the original frames 0, 1, and 3 by selecting them from the sequence. To reconstruct original frame 2, one needs to build it from 2e and 2o fields in the {1o, 2e}, {2o, 3e} sequence.

The advanced 2:3:3:2 telecine pattern is:
{0o, 0e}, {1o, 1e, 1o}, {2e, 2o, 2o}, {3e, 3o}, . . .
   Now grouped to emphasis the resulting interlaced frames:
{0o, 0e}, {1o, 1e}, {1o, 2e}, {2o, 2e}, {3o, 3e}, . . .
   Notice that 4 out of 5 interlaced frames have fields from the same original frame number. Only the third frame contains fields from different original frames. Simply dropping this frame results in the original progressive frame sequence.

The Pipeline Selector reads the input format and the desired output format from the CFilmSettings object and selects one of six pipelines to send the input frame through.

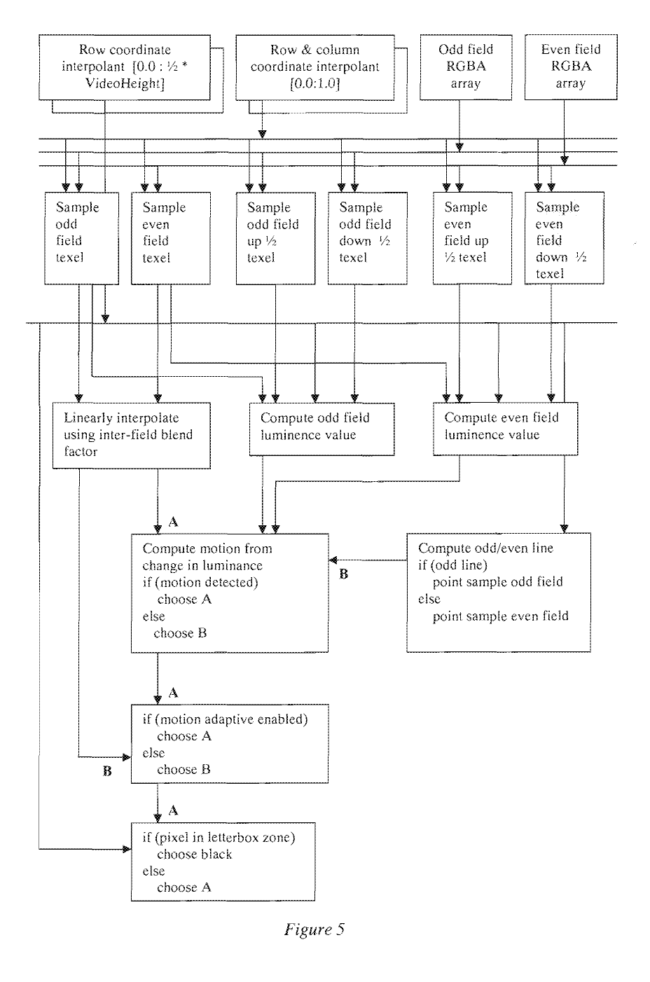

The Letterbox mask, deinterlacing and cadence resampling module is selected when the user indicates that 60i input is to be converted to 24p or 30p formats. This module deinterlaces two frames and uses information from each frame for cadence resampling. This module also writes black in the letterbox region. FIG. 5 shows this module in detail.

The Letterbox mask, inverse telecine module is selected when the user indicates that 24p telecine standard or advanced is to be passed through or converted to 24p standard or advanced telecine formats. Even when conversion is not selected, the frames need to be inverse telecined in order for the film processing module to properly apply film grain and imperfections. This module also writes black in the letterbox region.

The Letterbox mask, frame copy module can be selected when the user indicates that 60i is to be passed through as 60i or when 30p is to be passed through as 30p. No conversion is possible with this module. This module also writes black in the letterbox region.

The Film process module, which is common to both the 24p and 30p/60i pipelines, transforms the RGB colors with a color transformation matrix. This transformation applies adjustments to hue, saturation, brightness, and contrast most preferably by using one matrix multiply. Midtones are preferably adjusted using a non-linear formula. Then imperfections (for example, dust, fiber, hair, chemical burns, scratches, etc.) are blended in. The final step applies the simulated film grain.

Interlace Using Forward Telecine takes processed frames that have a temporal frequency of 24 frames per second and interlaces fields using the forward telecine method. The user can select the standard telecine or advanced telecine pattern. This module produces interlaced frames, most preferably at a frequency 30 frames per second. The resulting frames are written to the Frame output queue.

The Frame Copy module can simply copy the processed frame, with a temporal frequency of 30 frames per second (or 60 interlaced fields), to the Frame output queue.

The following code (presented in C) is preferred to implement the Pipeline Selector of an embodiment of the invention:

```
// Process frame buffer in-place
void CGPU::ProcessFrame(BYTE* pInBuffer /*in*/, BYTE* pOutBuffer /*out*/, long
buffSize)
{
#ifdef ENABLE_FILTER
    HRESULT hr;
    CSharedGraphicsDevice* pSharedGraphicsDevice = GetSharedGraphicsDevice( );
    IDirect3DDevice9* pD3DDevice = pSharedGraphicsDevice->LockDevice( );
    CFilmSettings* pFilmSettings = pSharedGraphicsDevice->LockSettings( );
    if (pFilmSettings->m_bypassOn)
    {
        // disable all effects
        pSharedGraphicsDevice->UnlockSettings( );
        pSharedGraphicsDevice->UnlockDevice( );
        memcpy(pOutBuffer, pInBuffer, buffSize);
        return;
    }
    if (pFilmSettings->m_resetPipeline)
    {
        ResetPipeline(pFilmSettings);
        pFilmSettings->m_resetPipeline = FALSE;
    }
    hr = m_pEffect->SetInt(“g_motionAdaptiveOn”, pFilmSettings-
>m_motionAdaptiveOn);
    // Begin scene drawing (queue commands to graphics card)
    pD3DDevice->BeginScene( );
#if 0
    m_gpuUtil.DumpFrameTag(pInBuffer, L“Ref”);
#endif
    //
    // Render Stage A (Deinterlace/recadence, film effect)
    //
    if (pFilmSettings->m_inVideoCadence == IVC_160)
    {
        if ((pFilmSettings->m_outVideoCadence == OVC_P24_STD) ||
(pFilmSettings->m_outVideoCadence == OVC_P24_ADV))
        {
            ProcessStageA_Recadence24P(pD3DDevice, pFilmSettings, pInBuffer);
        }
        else if (pFilmSettings->m_outVideoCadence == OVC_P30)
        {
            // Deinterlace 60i to 30p
            ProcessStageA_Simple(pD3DDevice, pFilmSettings, pInBuffer,
“ProcessField”);
        }
        else
        {
            // don't deinterlace, just copy frame as is
            ProcessStageA_Simple(pD3DDevice, pFilmSettings, pInBuffer,
“CombineField”);
        }
    }
    else if (pFilmSettings->m_inVideoCadence == IVC_P30)
    {
        // don't deinterlace, just copy frame as is
        ProcessStageA_Simple(pD3DDevice, pFilmSettings, pInBuffer,
“CombineField”);
    }
    else if (pFilmSettings->m_inVideoCadence == IVC_P24)
    {
        ProcessStageA_UnTelecine(pD3DDevice, pFilmSettings, pInBuffer);
    }
    //
    // Render Stage B (Interlace video)
    //
    if ((pFilmSettings->m_outVideoCadence == OVC_P24_STD) || (pFilmSettings-
>m_outVideoCadence == OVC_P24_ADV))
    {
        BOOL doAdvanced = (pFilmSettings->m_outVideoCadence == OVC_P24_ADV);
        ProcessStageB_Telecine(pD3DDevice, doAdvanced);
    }
    else
    {
        ProcessStageB_Simple(pD3DDevice);
    }
    // End scene drawing (submit commands to graphics card)
    hr = pD3DDevice->EndScene( );
    // Read out the last processed frame into the output buffer.
    // We read an older frame so that we dont block on graphics card
    // which is rendering at GetEnd( )->Prev( )
        FrameIter* pFrameIter = m_resultQueue.GetFront( );
    Frame* pFrame = pFrameIter->Get( );
    m_gpuUtil.ReadFrame(pD3DDevice, pFrame->m_pRenderTarget, pOutBuffer);
#if 0
    m_gpuUtil.DumpFrame(pOutBuffer);
#endif
    pSharedGraphicsDevice->UnlockSettings( );
    pSharedGraphicsDevice->UnlockDevice( );
#endif
}
```

In a non-limiting embodiment, the invention preferably uses a Stream Programming Model (Stream Programming) to process the video frames. Stream Programming is a programming model that makes it much easier to develop highly parallel code. Common pitfalls in other forms of parallel programming occur when two threads of execution (threads) access the same data element, where one thread wants to write and the other wants to read. In this situation, one thread must be blocked while the other accesses the data element. This is highly inefficient and adds complexity. Stream Programming avoids this problem because the delivery of data elements to and from the threads is handled explicitly by the framework runtime. In Stream Programming, Kernels are programs that can only read values from their input streams and from global variables (which are read-only and called Uniforms). Kernels can only write values to their output stream. This rigidity of data flow is what allows the Kernels to be executed on hundreds of processing cores all at the same time without worry of corrupting data.

Direct3D 9 SDK is most preferably used to implement the Stream Programming Model and the video processing methods of the invention. However, the methods are not specific to Direct3D 9 SDK and can be implemented in any Stream Programming Model. In Direct3D a Kernel is called a Shader. In Direct3D 9 SDK, there are two different shader types: Vertex Shaders and Pixel Shaders. Most of the video processing preferably occurs in the Pixel Shaders. The Vertex Shaders can primarily be used to setup values that get interpolated across a quad (rectangle rendered using two adjacent triangles). In Pixel Shaders, the incoming interpolated data from a stream is called a Pixel Fragment.

In one embodiment, it is first preferred to set up the Direct3D runtime to render a quad that causes a Pixel Shader program to be executed for each pixel in the output video frame. Each Pixel Fragment in the quad gets added to one of many work task queues (Streams) that are streamed into Pixel Shaders (Kernels) running on each core in the graphics card. A Pixel Shader can be used for only producing the output color for the current pixel. The incoming stream contains information so that the Pixel Shader program can identify which pixel in the video output stream it is working on. The current odd and even video fields are stored as uniforms (read-only global variables) and can be read by the Pixel Shaders. The previous four deinterlaced/inverse telecined frames are also preferably stored as uniforms and are used by motion estimation algorithms.

The invention comprises preferred methods to convert 60 interlaced fields per second to 24 deinterlaced frames per second. The blending of 60i fields into full frames at a 24p sampling rate is most preferably done using a virtual machine that executes Recadence Field Loader Instructions. In this embodiment, one instruction is executed for every odd/even pair of 60i fields that are loaded into the Frame Input Queue. The instructions determine which even and odd fields are loaded into the pipeline, when to resample to synthesize a new frame, and the blend factor (linear interpolation factor) used during the resampling.

struct RecadenceInst
{

| | |
|---|---|
| BOOL m_loadFieldOdd; | // load odd field into pipeline |
| BOOL m_loadFieldEven; | // load even field into pipeline |
| int m_processFrame; | // combine two fields from head |
| | of pipeline |
| float m_blendFactor; | // factor to blend two fields from |
| | head of pipeline |

};
RecadenceInst g_recadenceInst[ ] =

| | | | | | | |
|---|---|---|---|---|---|---|
| { | // | load odd | load even | process | | blend |
| | { | TRUE, | TRUE, | TRUE, | 0.75f | }, |
| | { | TRUE, | TRUE, | TRUE, | 0.25f | }, |
| | { | FALSE, | TRUE, | FALSE, | 0.00f | }, |
| | { | TRUE, | TRUE, | TRUE, | 0.25f | }, |
| | { | TRUE, | FALSE, | TRUE, | 0.75f | }, |
| }; | | | | | | |

The instruction also indicates when the two fields from the head of the queue are to be deinterlaced and resampled into a progressive frame. Since there 4/5 as many frames in 24p than in 30p, four of the five instructions will process fields to produce a full frame. The two fields at the head of the pipeline are preferably processed with the specified blend factor.

The following sequence shows 30 interlaced frames per second and 60 progressive fields per second on a timeline:

| 60i Frames: | F0 | F1 | F2 | F3 | F4 | |
|---|---|---|---|---|---|---|
| 60i Fields: | o e | o e | o e | o e | o e | |
| Time(s): | 0/30 | 1/30 | 2/30 | 3/30 | 4/30 | . . . |

To convert to 24 frames per second, one needs to synthesize 4 new progressive frames from the original 5 frames. One approach is to start sampling at t=0/30 seconds(s):

| | | | | | | |
|---|---|---|---|---|---|---|
| 60i | Frames: | F0 | F1 | F2 | F3 | F4 |
| 60i | Fields: | o e | o e | o e | o e | o e |

| | | | | | |
|---|---|---|---|---|---|
| 24p | Frames: | x | x | x | x |

| | | | | | |
|---|---|---|---|---|---|
| Time(s): | 0/24 | 1/24 | 2/24 | 3/24 | . . . |

Notice that 0/24 s and 2/24 s samples, shown as an “x”, line up perfectly with either an odd or even field. These 24p frames can be constructed using standard deinterlacing techniques. Samples 1/24 s and 3/24 s occur at a time that is halfway between the odd and even field sample times (1/24 s=2.5/60 s). These samples are problematic because at t=1/24 s there is no original field to sample from. Since one is exactly halfway between an odd and even field sample, there is no bias towards any one field. The goal is to reconstruct a frame that renders objects in motion at their precise position at the desired sample time. One can synthesize a new frame by averaging the two 60i fields (blending 50% of from each pixel from the odd field with 50% from the even field). The resulting frame is less than ideal, but still looks good for areas of slow motion. But when the video is played at full speed, a temporal artifact is clearly visible. This is because half of the 24p frames contain motion artifacts and the other half does not. This is perceived as a 12 Hz stutter.

The invention preferably employs offset 24p sampling by (1/4*1/60)=1/240 second to avoid 12 Hz stutter artifact. The 12 Hz stutter problem is solved by introducing a time offset of 1/240 sec., or one quarter of 1/60 sec., to the 24p sampling timeline.

| | | | | | |
|---|---|---|---|---|---|
| 60i Frames: | F0 | F1 | F2 | F3 | F4 |
| 60i Fields: | o e | o e | o e | o e | o e |

| | | | | | |
|---|---|---|---|---|---|
| 24p Frames: | x | x | x | x | |
| Time(s): | q | r | s | t | . . . |

q = 0/24 + 1/240
r = 1/24 + 1/240
s = 2/24 + 1/240
t = 3/24 + 1/240

Now each sampling point “x” is consistently 1/240 second away from a field sample time. One now synthesizes a new frame by averaging two deinterlaced 60i fields with blend factors of 0.25 (25%) for the closest field and 0.75 (75%) for the next closest field. These blend factors then preferably are stored in the Recadence Field Loader Instructions.

On a pixel by pixel basis, the deinterlaced color value is preferably chosen from one of two possibilities: a) a color value from the 0.25/0.75 blending of the two nearest upsampled fields, or b) a color value from the odd field source (if we are rendering a pixel in the odd line in the destination) or even field source (if we are rendering a pixel in the even line). A motion metric is used to determine if color (a) or (b) is chosen.

An embodiment of the invention preferably uses bilinear sampling hardware, which is built into the graphics hardware and is highly optimized, to resize fields to full frame height. In this embodiment, multiple bilinear samples from different texture coordinates are averaged together to get an approximate Gaussian resizing filter. Odd fields are preferably sampled spatially one line higher than even fields. When upsampling even field images, it is preferred to use a slight texture coordinate offset (1/480 for standard definition) during sampling. This eliminates the bobbing effect that is apparent in other industry deinterlacers. Because of the special texture sampling hardware in graphics hardware, a bilinear sample takes the same amount of time as a point sampler. By using bilinear samples, one reduces the number of overall samples required, thereby reducing the overall sampling time.

For motion adaptive deinterlacing, the motion metric is preferably computed as follows: a) for the both the odd and even fields, sum three separate bilinear samples with different (U,V) coordinates such that we sample the current texel, ½ texel up, and ½ texel down, b) scale the red, green, and blue components by well known luminance conversion factors, c) convert the odd and even sums to luminance values by summing the color components together, d) compute the absolute difference between the odd and even luminance value, and e) compare the resulting luminance difference with the threshold value of 0.15f (0.15f is empirical). By summing three different bilinear samples together, one is in effect blurring the source image. If one does not blur the source fields before computing the difference, one can mistakenly detect motion wherever there are horizontal features.

One embodiment of the invention preferably uses graphics interpolation hardware to interpolate the current row number. The row number is used to determine if the current pixel is in the letterbox black region. If in the black region, the pixel shader returns the black color and stops processing. This early out feature reduces computation resources. Next follows the preferred pixel shader code that computes motion adaptive deinterlacing, resamples at a 24p cadence, and applies letterbox masking. The “g_evenFieldOfs.y” is a constant value that adjusts a texture coordinate position by ½ texel:

```
float4 ProcessFieldPS(VS_OUTPUT VSOUT) : COLOR
{
    float4 outColor : register(r0);
    if ((VSOUT.m_rowScaled < g_letterBoxLow) ||
(VSOUT.m_rowScaled > g_letterBoxHigh))
    {
        outColor = float4(0, 0, 0, 0);
    }
    else
    {
        float2 oddTexCoord = VSOUT.m_texCoord + g_oddFieldOfs;
        float2 evenTexCoord = VSOUT.m_texCoord +
        g_evenFieldOfs;
        float4 colA = tex2D(OddFieldLinearSampler, oddTexCoord);
        float4 colB = tex2D(EvenFieldLinearSampler, evenTexCoord);
        bool first = frac(VSOUT.m_rowScaled) < .25;
        // compute the blended sample
        outColor = lerp(colB, colA, g_fieldBlendFactor);
        if (g_motionAdaptiveOn)
        {
            // Move up ½ texel and sample
            colA += tex2D(OddFieldLinearSampler, oddTexCoord −
g_evenFieldOfs.y);
            colB += tex2D(EvenFieldLinearSampler, evenTexCoord −
g_evenFieldOfs.y);
            // Move down ½ texel and sample
            colA += tex2D(OddFieldLinearSampler, oddTexCoord +
g_evenFieldOfs.y);
            colB += tex2D(EvenFieldLinearSampler, evenTexCoord +
g_evenFieldOfs.y);
            // Compute difference
            float4 a = colA * float4(0.3086f, 0.6094f, 0.0820f, 0.0f);
            float lumA = a.r + a.g + a.b;
            float4 b = colB * float4(0.3086f, 0.6094f, 0.0820f, 0.0f);
            float lumB = b.r + b.g + b.b;
            lumA = abs(lumA − lumB);
            if (lumA < 0.15f) // .15 is an empirical value
            {
                // Area of low motion; switch to weave
                if (first)
                {
                    outColor = tex2D(EvenFieldPointSampler,
evenTexCoord);
                }
                else
                {
                    outColor = tex2D(OddFieldPointSampler,
oddTexCoord);
                }
            }
        }
        outColor = FilmProcess(VSOUT, outColor);
    }
    return outColor;
}
```

Next is discussed the preferred methods used to convert 60 interlaced fields per second to 30 deinterlaced frames per second. The resampling of 60i fields into 30 full deinterlaced frames per second is done by leveraging a portion of the 60i to 24p deinterlacing code. In the 60i to 24p method, the fields that are loaded into the deinterlacer are preferably specified by the Recadence Field Loader Instructions. In 60i to 30p, one simply loads the odd and even fields for every frame. The field blend constant is always set to 0.0 (or 1.0 is equally valid). This approach leverages complicated code for more than one purpose. This method results in motion adaptive deinterlaced frames.

The preferred methods to convert telecined (standard and advanced) video, encoded as 60 interlaced fields per second, to 24 deinterlaced frames per second are next discussed. The original frames recorded at 24p and encoded using the telecine method (standard 2:3 and advanced 2:3:3:2 repeat pattern) are recovered using a virtual machine that executes UnTelecine Field Loader Instructions. One instruction is executed for every odd/even pair of 60i fields that are loaded into the Frame Input Queue. The following code shows the preferred UnTelecine Field Loader Instructions:

struct UnTelecineInst
{

| | |
|---|---|
| BOOL m_loadFieldOdd; | // load odd field into next full frame |
| BOOL m_loadFieldEven; | // load even field into next full frame |

};
UnTelecineInst g_stdUnTelecineInst[ ] =

| { | // | load odd | load even | |
|---|---|---|---|---|
| | { | TRUE, | TRUE | }, |
| | { | TRUE, | TRUE | }, |
| | { | FALSE, | TRUE | }, |
| | { | TRUE, | FALSE | }, |
| | { | TRUE, | TRUE | }, |

};
UnTelecineInst g_advUnTelecineInst[ ] =

| { | // | load odd | load even | |
|---|---|---|---|---|
| | { | TRUE, | TRUE | }, |
| | { | TRUE, | TRUE | }, |
| | { | FALSE, | FALSE | }, |
| | { | TRUE, | TRUE | }, |
| | { | TRUE, | TRUE | }, |

};

When an odd or even field is loaded, the m_oddFieldLoaded or m_evenFieldLoaded flag is set. When both flags are set, i.e. two fields have been loaded, the inverse telecine module combines the two fields into one full progressive 24p frame.

The virtual machine instruction pointer is preferably aligned with the encoded 2:3 (or 2:3:3:2) pattern. In order to do this reliably, the field difference history information is preferably stored for the last about 11 frames (10 even field deltas, 10 odd field deltas, 20 difference values in one example). In one embodiment, the TelecineDetector module performs this task. The TelecineDetector stores the variance between even fields or odd fields in adjacent frames. The variance is defined as the average of the difference between a channel in each pixel in consecutive even or odd fields squared. The TelecineDetector generates a score given the history, a telecine pattern, and an offset into the pattern. The score is generated by looking at what the pattern is supposed to be. If the fields are supposed to be the same, it adds the variance between those two fields to the score. The pattern and offset that attains the minimum score is most likely to be the telecine pattern the video was encoded with, and the offset is the stage in the pattern of the newest frame. The preferred code for the TelecineDetector is:

| // We need to keep 10 frames of history | |
|---|---|
| #define DIFF_HISTORY_LENGTH (10) | |
| enum TELECINE_TYPE | |
| { | |
| TT_STD_A = 0, | // standard 2:3 telecine |
| TT_STD_B, | // standard 2:3 telecine |
| TT_ADV_A, | // advanced 2:3:3:2 telecine |
| TT_ADV_B, | // advanced 2:3:3:2 telecine |
| TT_UNKNOWN, | |

```
};
//
// The field difference computed between the current field and the previous field is
// stored in the current field's obect. Thus when detelecine the current frame, we
// can look at the past frame differences to determine which decode instruction we
// should be on.
//
// Standard Telecine Pattern
// Pattern repeats after 10 fields (5 frames)
// ! !
//3 2 3 2 3 2 3 2 3
//x xx aa bb bc cd dd ee ff fg gh hh
// dd dd sd dd ds dd dd sd dd ds
// i0 i1 i2 i3 i4 i0 i1 i2 i3 i4
char* g_pStdTcn_A = “dd dd ds dd sd”;
char* g_pStdTcn_B = “dd dd sd dd ds”;
// Advanced Telecine Pattern
// Pattern repeats after 10 fields (5 frames)
// ! !
// 2 2 3 3 2 2 3 3 2
// xx aa bb bc cc dd ee ff fg gg hh
// dd dd sd ds dd dd dd sd ds dd
// i0 i1 i2 i3 i4 i0 i1 i2 i3 i4
char* g_pAdvTcn_A = “dd dd sd ds dd”;
char* g_pAdvTcn_B = “dd dd ds sd dd”;
char * g_ppTcnPatterns[ ] = { g_pStdTcn_A, g_pStdTcn_B, g_pAdvTcn_A, g_pAdvTcn_B };
const int g_TcnPatternCount = sizeof(g_ppTcnPatterns) / sizeof(g_ppTcnPatterns[0]);
class TelecineDetector
{
public:
    void Reset( )
    {
        m_History.clear( );
    }
    // This function finds the minimum score for all the possible
            // (telecine pattern, offset) pairs
    void DetectState(I32 frameIndex, float OddDiffSq /*in*/, float EvenDiffSq
```

/*in*/,

```
            TELECINE_TYPE* pTelecineType /*out*/, int* pIndex /*out*/)
    {
        AddHistory(frameIndex, OddDiffSq, EvenDiffSq);
        float best = −1.0f;
        *pTelecineType = TT_UNKNOWN;
        for(int j = 0; j < g_TcnPatternCount; ++j)
        {
            for(int i = 0; i < 5; ++i)
            {
                float s = Score(g_ppTcnPatterns[j], i);
                if(s < best || (i == 0 && j == 0))
                {
                    best = s;
                    *pTelecineType = (TELECINE_TYPE)j;
                    *pIndex = i;
                }
            }
        }
    }
protected:
    // One history sample
    struct Frame
    {
        I32 frameIndex;
        float OddDiffSq;
        float EvenDiffSq;
        Frame(I32 f, float o, float e) : frameIndex(f), OddDiffSq(o),
```

EvenDiffSq(e) { }

```
    };
    // A list of history samples
    std::list < Frame > m_History;
    // Get the index'th pattern element
    void GetPatternElement(char * pattern, int index, bool & odd, bool & even)
    {
        while(index < 0)
            index += 5;
        while(index >= 5)
        index −= 5;
        odd = pattern[index * 3 + 1] == ‘s’;
    even = pattern[index * 3 + 0] == ‘s’;
    }
    // Compute the score for a given pattern and offset
        float Score(char * pattern, int offset)
        {
        float s = 0.0f;
        I32 base = m_History.front( ).frameIndex;
        for(std::list < Frame >::iterator i = m_History.begin( ); i !=
```

m_History.end( ); ++i)

```
        {
            bool oddsame, evensame;
            GetPatternElement(pattern, offset − ((int)base − (int)i-
```

>frameIndex), oddsame, evensame);

```
            float zodd = i->OddDiffSq;
            float zeven = i->EvenDiffSq;
            // If the fields are supposed to be the same, add the variance to
```

the score.

// If they are supposed to be different, it doesn't matter

whether they are the same or not

```
                if(oddsame)
                s += zodd;
            if(evensame)
                s += zeven;
        }
        return s;
    }
        void AddHistory(I32 frameIndex, float OddDiffSq, float EvenDiffSq)
    {
        Frame f(frameIndex, OddDiffSq, EvenDiffSq);
        m_History.push_front(f);
        while(m_History.size( ) > DIFF_HISTORY_LENGTH)
            m_History.pop_back( );
    }
};
```

Next follows the preferred Pixel Shader subroutine FilmProcess( ) that applies color adjustments, imperfections, and simulated film grain:

```
float4 FilmProcess(VS_OUTPUT VSOUT, float4 color)
{
    // Apply color matrix for hue, sat, bright, contrast
    // this compiles to 3 dot products:
    color.rgb = mul(float4(color.rgb, 1), (float4×3)colorMatrix);
    // Adjust midtone using formula:
    // color + (ofs*4)*(color − color*color)
    // NOTE: output pixel format = RGBA
    float4 curve = 4.0f * (color − (color * color));
    color = color + (float4(midtoneRed, midtoneGreen, midtoneBlue,
    0.0f) * curve);
    // Apply imperfections/specks
    float4 c = tex2D(Specks, VSOUT.m_texCoord + g_frameOfs);
    color.rgb = ((1.0f − c.r) * color.rgb); // apply black specks
    color.rgb = ((1.0f − c.g) * color.rgb) + c.g; // apply white specks
    // Apply film grain effect
    // TODO: confirm correct lum ratios
    c = color * float4(0.3086f, 0.6094f, 0.0820f, 0.0f);
    float lum = c.r + c.g + c.b;
    c = tex2D(FilmGrain, VSOUT.m_texCoord + g_frameOfs);
// TODO: are we using correct offsets here?
    lum = 1.0f − ((1.0f − lum) * c.a * grainPresence);
    color = color * lum;
    color = clamp(color, 0, 1);
    return color;
}
```

FilmProcess( ) takes as input a VSOUT structure (containing interpolated texture coordinate values used to access the corresponding pixel in input video frames) and an input color fragment represented as red, green, blue, and alpha components. The first line applies the color transform matrix which adjusts the hue, saturation, brightness, and contrast. Color transformation matrices are as commonly used. The next line computes a non-linear color curve tailored to mimic film saturation curves.

The invention preferably computes a non-linear color curve tailored to mimic film saturation curves. The curve is a function of the fragment color component. Three separate curves are preferably computed: red, green, and blue. The curve formula is chosen such that it is efficiently implemented on graphics hardware, preferably:

color=color+(adjustmentFactor*4.0)*(color−color*color)

The amount of non-linear boost is modulated by the midtoneRed, midtoneGreen, and midtoneBlue uniforms (global read-only variables). These values are set once per frame and are based on the input from the user interface.

The invention preferably uses a procedural noise function, such as Perlin or random noise, to generate film grain textures (preferably eight) at initialization. Each film grain texture is unique and the textures are put into the texture queue. Textures are optionally used sequentially from the queue, but random transformations on the texture coordinates can increase the randomness. Textures coordinates can be randomly mirrored or not mirrored horizontally; and/or rotated 0, 90, 180, 270 degrees. This turns, for example, 8 unique noise textures into 64 indistinguishable samples.

Film Grain Textures are preferably sampled using a magnification filter so that noise structures will span multiple pixels in the output frame. This mimics real-life film grain when film is scanned into digital images. Noise that varies at every pixel appears as electronic noise and not film grain.

A system of noise values (preferably seven) can be used to produce color grain where the correlation coefficient between each color channel is determined by a variable graincorrelation. If 7 noise values are labeled as follows: R, G, B, RG, RB, GB, RGB, the first 3 of these values can be called the uncorrelated noise values, the next 4 can be called the correlated noise values. When sampling a noise value for a color channel, one preferably takes a linear combination of every noise value that contains that channel. For example, when sampling noise for the red channel, one could take the noise values R, RG, RB, and RGB. Let c=grainCorrelation. Now, three functions can be created that define the transition from uncorrelated noise to correlated noise, grain1(c), grain2(c), and grain3(c). These functions preferably have the property that 0<grainX(c)<1, grain1(c)+grain2(c)+grain3(c)=1 for 0<c<1, grain1(0)=1, and grain3(1)=1. Now define the following linear combination of the noise channels, the sampling for R is shown below:

grain1(c)*R+0.5f*grain2(c)*(RG+RB)+grain3(c)*RGB

This will result in a smooth transition between uncorrelated noise and fully correlated (R=G=B) noise. Preferred code follows:

```
float4 FilmProcess(VS_OUTPUT VSOUT, float4 color)
{
    // Apply color matrix for hue, sat, bright, contrast
    // this compiles to 3 dot products:
    color.rgb = mul(float4(color.rgb, 1), (float4×3)colorMatrix);
    // Adjust midtone using formula:
    // color + (ofs*4)*(color − color*color)
    // NOTE: output pixel format = RGBA
    float4 curve = 4.0f * (color − (color * color));
    color = color + (float4(midtoneRed, midtoneGreen, midtoneBlue,
    0.0f) * curve);
    // Apply imperfections/specks
    float4 c = tex2D(Specks, VSOUT.m_texCoord + g_frameOfs);
    color.rgb = ((1.0f − c.r) * color.rgb); // apply black specks
    color.rgb = ((1.0f − c.g) * color.rgb) + c.g; // apply white specks
    // Apply film grain effect
    // TODO: confirm correct lum ratios
    // Y709 = 0.2126R + 0.7152G + 0.0722B
    // Uncorrelated noise R = c1.r
    // Uncorrelated noise G = c1.g
    // Uncorrelated noise B = c1.b
    // Correlated noise RG = c2.r
    // Correlated noise RB = c2.g
    // Correlated noise GB = c2.b
    // Correlated noise RGB = c2.a
    float2 texCoord = VSOUT.m_noiseTexCoord;
    float lum = dot(color.rgb, float3(0.3086f, 0.6094f, 0.0820f));
    float4 c1 = tex2D(FilmGrainA, texCoord);
    float4 c2 = tex2D(FilmGrainB, texCoord);
    c.r = grain3 * c2.a + grain2 * (c2.r + c2.g) + grain1 * c1.r;
    c.g = grain3 * c2.a + grain2 * (c2.r + c2.b) + grain1 * c1.g;
    c.b = grain3 * c2.a + grain2 * (c2.g + c2.b) + grain1 * c1.b;
    c −= 0.5f; // normalize noise
    c *= (1.0f − lum); // make noise magnitude inversely porportional
    to brightness
    color += c * grainPresence * 2.0f;
    color = clamp(color, 0, 1);
    return color;
}
```

Film Grain Textures are preferably sampled using bilinear sampling graphics hardware to produce smooth magnification. The grain sample color is adjusted based on the brightness (lumen value) of the current color fragment and a user settable grain presence factor. The preferred formula is: grain=(1.0f−lum)*(grainSample−0.5f)*grainPresence*2. This makes film grain structures more noticeable in dark regions and less noticeable in brighter regions. The grain color is then added to the output color fragment by:

color=color+grain.

Imperfections (dust, fiber, scratches, etc.) are preferably rendered using graphics hardware into a separate frame sized buffer (Imperfection Frame). A unique Imperfection Frame can be generated for every video frame. Details of how the Imperfection Frame is created are discussed below. In one embodiment, the Imperfection Frame has a color channel that is used to modulate the color fragment before the Imperfection color fragment is added in.

In a non-limiting embodiment of the present invention, the pipeline preferably enables a fragment shader program to perform all the following operations on each pixel independently and in one pass: motion adaptive deinterlace, recadence sampling, inverse telecine, apply linear color adjustments, non-linear color adjustments, imperfections, and simulated film grain. Doing all these operations in one pass significantly reduces memory traffic on the graphics card and results in better utilization of graphics hardware. The second pass interlaces or forward telecines processed frames to produce the final output frames that are recompressed.

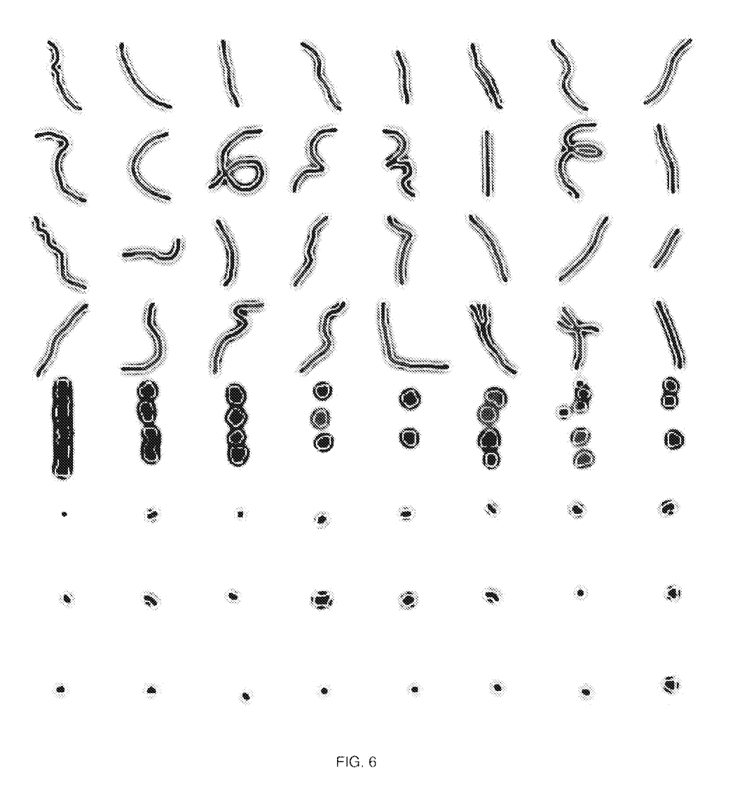

A texture atlas is preferably employed, such as shown in FIG. 6, to store imperfection subtextures for dust, fibers, hairs, blobs, chemical burns, and scratch patterns. The texture atlas is also used in the scratch imperfection module. Each subtexture is preferably 64×64 pixels. The texture atlas size can be adjustable with a typical value of about 10×10 (about 640×640 pixels). Using a texture atlas instead of individual textures improves performance on the graphics hardware (each texture has a fixed amount of overhead if swapped to/from system memory).

The texture atlas is preferably pre-processed at initialization time to soften and create subtle ringing around edges. This greatly increases the organic look of the imperfection subtextures. The method uses the following steps:
i. Ib=BlurrMore(Ia)
ii. Ic=Diff(Ib, GaussBlur(Ib, 2.5))
iii. Id=Ic+(Ic/2)
   Doing this once instead of during every frame improves performance.

Within a given category (dust, fiber, etc.) a subtexture can be randomly selected. The subtexture then preferably is applied to a quad that is rendered to the Imperfection Frame. In this embodiment, the quad is rendered with random position, rotation (about the X, Y, and Z axis), and scale. Rotation about the X and Y axis is optionally limited in order to prevent severe aliasing due to edge on rendering (in one instance it is preferred to limit this rotation to about ±22 degrees off the Z plane). Rotation values that create a flip about the X or Y can be allowed. Rotation about the Z axis is unrestricted. The subtexture can be rendered as black or white. The color can be randomized and the ratio of black to white is preferably controllable from the UI. Another channel is optionally used to store the modulation factor when the Imperfection Image is combined with the video frame. The subtextures are sampled using a bilinear minification filter, bilinear magnification filter, Linear MipFilter, and max anisotropy value of 1. These settings are used to prevent aliasing.

Many imperfection parameters are preferably randomized. Some parameters, such as frequency and size, are varied using a skewed random distribution. Random values are initially generated with an even distribution from 0.0 to 1.0. The random distribution is preferably then skewed using the exponential function in order to create a higher percentage of random samples to occur below a certain set point. Use of this skewed random function increases the realism of simulated imperfections.

The following code demonstrates an exponentially skewed random function:

```
// Exponential distribution skews results towards range_min.
// Good values for exponent are:
//  1.3 yields ~59% results in the lower half of range
//  1.5 yields ~64% results in the lower half of range
//  2.0 yields ~70% results in the lower half of range
//  2.5 yields ~75% results in the lower half of range
float Specks::RandomExpDist(const Range& r, float exponent)
{
      float ratio = float(rand( )) / float(RAND_MAX);
      ratio = pow(ratio, exponent);
      return (ratio * (r.m_max − r.m_min)) + r.m_min;
}
```

Scratch type imperfections can be different than dust or fiber type imperfections in that they can optionally span across multiple frames. In order to achieve this effect, every scratch deployed by the invention preferably has a simulated lifetime. When a scratch is created it preferably has a start time, life time, and coefficients to sine wave equations used to control the path the scratch takes over the frame. A simulation system preferably simulates film passing under a mechanical frame that traps a particle. As the simulation time step is incremented the simulated film is moved through the mechanical frame. When start time of the scratch equals the current simulation time, the scratch starts to render quads to the Imperfection Frame. The scratch continues to render until its life time is reached.

Scratch quads are preferably rendered stacked vertically on top of each other. Since the scratch path can vary from left to right as the scratch advances down the film frame, the scratch quads can be rotated by the slope of the path using the following formula:

roll=(pi/2.0f)+a tan 2(ty1−ty, tx1−tx).

Scratch size is also a random property. Larger scratches are rendered with larger quads. Larger quads require larger time steps in the simulation. Each scratch particle requires a different time delta. The invention solves this problem by running a separate simulation for each scratch particle (multiple parallel simulations). This works for simulations that do not simulate particle interactions. When the particle size gets quite small, one does not typically want to have a large number of very small quads. Therefore, it is preferred to enforce a minimum quad size, and when the desired size goes below the minimum, one switches to the solid scratch size and scale only in the x scratch width dimension.

Scratch paths can be determined using a function that is the sum of three wave functions. Each wave function has frequency, phase, and magnitude parameters. These parameters can be randomly determined for each scratch particle. Each wave contributes variations centered around a certain frequency: 6 Hz, 120 Hz, and 240 Hz.

Preferred code for the imperfections module follows.

An embodiment of the invention also preferably employs advanced deinterlacing and framerate re-sampling using true motion estimation vector fields. The preferred True Motion Estimator (TME) of an embodiment of the invention is a hierarchical and multipass method. It preferably takes as input an interlaced video stream. The images are typically sampled at regular forward progressing time intervals (e.g., 60 Hz). The output of the TME preferably comprises a motion vector field (MVF). This is optionally a 2D array of 2-element vectors of pixel offsets that describe the motion of pixels from one video frame (or field) image to the next. The application of motion offsets to a video frame, where time=n−1, will produce a close approximation of the video frame at time=n. The motion offsets can be scaled by a blendFactor to achieve a predicted frame between the frames n−1 and n. For example if the blendFactor is 0.25, and the motion vectors in the field are multiplied by this factor, then the resulting predicted frame is 25% away from frame n−1 toward n. Varying the blend factor from 0 to 1 can cause the image to morph from frame n−1 to the approximate frame n.

Framerate resampling is the process of producing a new sequence of images that are sampled at a different frequency. For example, if the original video stream was sampled at 60 Hz and you want to resample to 24 Hz, then every other frame in the new sequence lies halfway between two fields in the original sequence (in the temporal domain). You can use a TME MVF and a blend factor to generate a frame at the precisely desired moment in the time sequence.

An embodiment of the present invention optionally uses a slight temporal offset of ¼ of 1/24 of a second in its resampling from 60 interlaced to 24 progressive. This generates a new sampling pattern where the blendfactor is always 0.25 or 0.75. In this embodiment, the present invention preferably generates reverse motion vectors (i.e., one runs the TME process backwards as well as forwards). When the sampling is 0.75 between two fields, use the reverse motion vectors and a blend factor of 0.25. The advantage of this approach is that one is never morphing more than 25% away from an original image. This results in less distortion. An excellent background in true motion estimation and deinterlacing is given by E. B. Bellers and G. de Haan, De-interlacing: A Key Technology for Scan Rate Conversion (2000).

Field offsetting and smoothing is preferably done as follows. A video field image contains the odd or even lines of a video frame. Before an odd video field images can be compared to an even field image, it must be shifted up or down by a slight amount (usually a ½ pixel or ¼ pixel shift) to account for difference in spatial sampling. The invention shifts both fields by an equal amount to align spatial sampling and to degrade both images by the same amount (resampling changes the frequency characteristics of the resulting image).

Near horizontal lines in the original field usually exhibit quite noticeable aliasing artifacts. These artifacts may cause problems with the motion finding process and may produce false motion vectors. At the same time or at substantially the same time that the video fields are re-sampled to fix spatial alignment, high-frequency smoothing is preferably also applied to reduce the effect of aliasing.

In addition to the color channels of the image, it is preferred to add a fourth channel that is the edge map of the image. The edge map values can be computed from the sum of the horizontal and vertical gradients (sum of dx and dy) across about three pixels. Any edge image processing, such as sobel edge detector, will work. The addition of this edge map improves the motion vectors by adding an additional cost when edges don't align during the motion finding. This extra penalty helps assure that the resulting motion vectors will map edges to edges.

In computing the TME for one image pair, denoted I(n−1) for image at time=n−1 and I(n), the motion estimation algorithm is performed on different sized levels of the image pair. The first step in the algorithm is to resize the interlaced image I(n−1) to one-half size in each dimension. The process is repeated until one has a final image that is only a pixel in size. This is sometimes called an image pyramid. In the current instance of the preferred method, one gets excellent results with only the first four levels.

It is preferred to perform the motion estimation on smaller sizes because it more efficiently detects large scale motion, or global motion, such as camera panning, rotations, zoom, and large objects moving fast. The motion that is estimated on a smaller image is then used to seed the algorithm for the next sized image. The motion estimation is repeated for the larger sized images and each step adds finer grain detail to the motion vector field. The process is repeated until the motion vector field for the full size images is computed.

The actual motion finding is preferably done using blocks of pixels (this is a configurable parameter, in one instance of the invention it is set to 8×8 pixel blocks). In this embodiment, the algorithm sweeps over all the blocks in the previous image I(n−1) and searches for a matching block in the current image I(n). The search for a block can be done by applying a small offset to the block of pixels and computing the Sum of the Absolute Differences (SAD) metric to evaluate the match. The offsets are selected from a set of candidate vectors. Candidate vectors can be chosen from neighboring motion vectors in the previous iteration (spatial candidate), from the smaller image motion vectors (global motion candidate), from the previous motion vector (temporal candidate). The candidate set is further extended by applying a random offset to each of the candidate vectors in the set. Each offset vector in the final candidate set preferably has a cost penalty associated with it. This is done to shape the characteristics of the resulting motion vector field. For example, if we want a smoother motion field we lower the penalty for using spatial candidates. If one wants smoother motion over time, lower the penalty for temporal candidates.

Preferred code for the advanced deinterlacing and framerate re-sampling using true motion estimation vector fields method of the invention next follows.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A digital video processing method comprising the steps of:
receiving a digital video stream comprising a plurality of frames;
adding a plurality of film effects to the video stream; and
outputting the video stream with the added film effects; and
wherein for each frame the outputting step occurs within less than approximately one second.

2. The method of claim 1 wherein the adding step comprises adding at least two effects selected from the group consisting of letterboxing, simulating film grain, adding imperfections simulating dust, fiber, hair, scratches, making simultaneous adjustments to hue, saturation, brightness, and contrast and simulating film saturation curves.

3. The method of claim 2 wherein the adding step comprises simulating film saturation curves via a non-linear color curve.

4. The method of claim 2 wherein the adding step comprises simulating film grain by generating a plurality of film grain textures via a procedural noise function and by employing random transformations on the generated textures.

5. The method of claim 2 wherein the adding step comprises adding imperfections generated from a texture atlas and softened to create ringing around edges.

6. The method of claim 2 wherein the adding step comprises adding imperfections simulating scratches via use of a start time, life time, and an equation controlling a path the scratch takes over subsequent frames.

7. The method of claim 2 wherein the adding step comprises employing a stream programming model and parallel processors causing the adding step for each frame to occur in a single pass through the parallel processors.

8. The method of claim 1 additionally comprising the step of converting the digital video stream from 60 interlaced format to a deinterlaced format by loading odd and even fields from successive frames, blending using a linear interpolation factor, and, if necessary, offset sampling by a predetermined time to avoid stutter artifacts.

9. An apparatus for altering a digital image, said apparatus comprising:
an input receiving a digital image;
software embodied on a computer-readable meadium adding a plurality of film effects to the digital image;
one or more processors performing operations of the software and thus producing a resulting digital image; and
an output sending the resulting digital image within less than approximately one second from receipt of the ditital image by said input.

10. The apparatus of claim 9 wherein said plurality of film effects comprises two or more elements selected from the group consisting of letterboxing, simulating film grain, adding imperfections simulating dust, fiber, hair, scratches, making simultaneous adjustments to hue, saturation, brightness, and contrast, and simulating film saturation curves.

11. The apparatus of claim 10 wherein said film saturation curves are added via a non-linear color curve.

12. The apparatus of claim 9 wherein one of said film effects comprises film grain generated a plurality of film grain textures via a procedural noise function and by employing random transformations on the generated textures.

13. The apparatus of claim 9 wherein one of said film effects comprises imperfections generated from a texture atlas of said software to create ringing around edges.

14. The apparatus of claim 9 wherein one of said film effects comprises simulation of scratches via use of a start time, life time, and an equation controlling a patch the scratch takes over subsequent frames.

15. The apparatus of claim 9 wherein said software and processors comprise a stream programming model and parallel processors causing said plurality of film effects to be added in a single pass through said parallel processors.

16. The apparatus of claim 9 wherein at least one of said processors converts said resulting digital image from 60 interlaced format to a deinterlaced format by loading odd and even fields from successive frames, blending using a linear interpolation factor, and, if necessary, offset sampling by a predetermined time to avoid stutter artifacts.

17. Computer software stored on a computer-readable medium for manipulating a digital video stream, said software comprising:
software accessing an input buffer into which at least a portion of said digital video stream is at least temporarily stored; and
software adding a plurality of film effects to at least a portion of said digital video stream within less than approximately one second.

18. The computer software of claim 17 wherein said adding software adds at least two effects selected from the group consisting of letterboxing, simulating film grain, adding imperfections simulating dust, fiber, hair, scratches, making simultaneous adjustments to hue, saturation, brightness, and contrast and simulating film saturation curves.

19. The computer software of claim 17 wherein said adding software simulates film saturation curves via a non-linear color curve.

20. The computer software of claim 17 wherein said adding software simulates film grain by generating a plurality of film grain textures via a procedural noise function and by employing random transformations on the generated textures.

21. The computer software of claim 17 wherein said adding software adds imperfections to at least a portion of said digital video stream by accessing a texture atlas to create ringing around edges.

22. The computer software of claim 17 wherein said adding software adds imperfections simulating scratches having a start time, a life time, and an equation controlling a path the scratch takes over subsequent frames.

23. The computer software of claim 17 wherein said adding software employs a stream programming model for implementation on parallel processors to allow the plurality of effects to occur in a single pass through the parallel processors.

24. The computer software of claim 17 additionally comprising software converting the digital video stream from 60 interlaced format to a deinterlaced format by loading odd and even fields from successive frames, blending using a linear interpolation factor, and, if necessary, offset sampling by a predetermined time to avoid stutter artifacts.
